(19) United States
(12) Patent Application Publication
(10) Pub. No.: US 2026/0251795 A1
(43) Pub. Date: Aug. 27, 2026

(54) LiDAR-BASED DETECTION SYSTEM

(71) Applicant: Patrick Blattner, Dana Point, CA (US)

(72) Inventor: Patrick Blattner, Dana Point, CA (US)

(21) Appl. No.: 19/551,164

(22) Filed: Feb. 26, 2026

Related U.S. Application Data
(60) Provisional application No. 63/763,966, filed on Feb. 27, 2025.

(51) Int. Cl. G01S 17/89; B61L 23/00; G01S 7/00; G01S 7/481

(52) U.S. Cl. CPC G01S 17/89; B61L 23/00; G01S 7/003; G01S 7/4815

(57) ABSTRACT

The system creates dynamic zones over LiDAR telemetry data detecting anomalies proximate to a railway. The system includes LiDAR emitters and LiDAR sensors engaged to the front and rear of a train. The environment proximate to a railway is dynamically scanned, and the scanned LiDAR data is compared and transformed into composite LiDAR data by a LiDAR processor having advanced machine learning algorithms. A detection module reviews the composite LiDAR data to identify anomalies in the environment and fences surrounding the railway. A mapping engine assigns coordinates to the identified anomalies. A communication module transmits the coordinates of the anomalies for further investigation or action.

### CROSS-REFERENCE TO RELATED APPLICATIONS

This application claims priority to provisional application number 63/763966, filed February 27, 2025, the entire contents of which are hereby incorporated by reference.

### FEDERALLY SPONSORED RESEARCH AND DEVELOPMENT

Not Applicable

### JOINT RESEARCH AGREEMENT

None.

### FIELD OF THE INVENTION

The invention relates to LIDAR and LIDAR equipment, with an emitter to transmit sensed LIDAR data to an antenna receiver, for detecting and recording the integrity and the existence of breaches in perimeter and corridor fencing proximate to railways, for improved safety to rail works and individuals.

### BACKGROUND OF THE INVENTION

Many remote areas can benefit from monitoring via LIDAR for safety. For example, railways and railway yards cover large areas which are not easily accessible for observation and monitoring. Also, remote border areas for railways and railway yards are often difficult to monitor due to their geographical isolation, which makes it challenging to access and maintain the necessary infrastructure for safety observation. However, advances in LiDAR technology and point-to-point devices have made it possible to remotely monitor these areas for obstructions, breaches in fencing enabling unauthorized access and perimeter intrusions, nefarious activities and safety risks.

LiDAR technology is a remote sensing technology that uses laser beams to create a 3D map of an environment. It is a reliable and accurate way to detect and to record environment structure, and it can detect even small changes occurring within monitored zones. By using LiDAR technology, remote areas may be monitored without having to have personnel physically present in the geographic areas. Any remote area which requires monitoring may benefit from the invention.

Point-to-point devices may be used to transfer data from LiDAR sensors to a remote location for analysis. These devices may use wireless or wired technology to transmit data over long distances, making it possible to monitor remote areas without the need for physical access. The data may also be analyzed in real-time, allowing for a rapid response for correction of an undesirable breach or safety concern.

Data from LiDAR sensors may also be temporarily stored for transfer into a LiDAR communication network making it possible to monitor remote areas without the need for physical access. The data can be periodically or intermittently communicated for analysis, allowing for a rapid response for correction of an undesirable breach or safety concern.

The utilization of LiDAR equipment, sensors and communication devices provide a reliable and accurate way to detect perimeter breaches and intrusions or other nefarious activities in remote locations. The LiDAR equipment, sensors and communication devices eliminate the need for physical access to remote and locations which are difficult to monitor, reducing the risk to security personnel. The LiDAR equipment, sensors and communication devices provide a sustainable and cost-effective solution for monitoring remote areas.

Remote LiDAR data receiving equipment or installations may be powered by solar panels, wind energy, and other types of known power sources. Point-to-point LiDAR devices have the potential to revolutionize railway security, or railyard perimeter security by providing a reliable and accurate way to detect perimeter breach locations, intrusions and nefarious activities in remote locations.

Railways and railyards are dangerous locations having numerous safety concerns. Safety considerations include debris on the tracks and breaches in perimeter fencing which may expose individuals to moving trains. Traditional methods of debris detection and perimeter breaches may be time-consuming and unreliable, leading to enhanced safety and security risks. However, by using LiDAR sensors with perception software and artificial intelligence, railways may improve their safety measures and create a safer environment for everyone.

Perimeter and boundary fence breaches pose a significant liability for train operators, allowing unauthorized access that can lead to injuries, theft, or derailment hazards. Current inspection methods rely on periodic manual checks, which are inefficient and prone to human error.

The art referred to and/or described above is not intended to constitute an admission that any patent, publication or other information referred to herein is “prior art” with respect to this invention. In addition, this section should not be construed to mean that a search has been made or that no other pertinent information as defined in 37 C.F.R. §1.56(a) exists.

All U.S. patents and applications and all other published documents mentioned anywhere in this application are incorporated herein by reference in their entirety.

Without limiting the scope of the invention, a brief description of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided for the purposes of complying with 37 C.F.R. § 1.72.

### SUMMARY OF THE INVENTION

The present invention relates to a LiDAR-based system for detecting breaches in perimeter fencing and along railway tracks. Using a LiDAR Platform, this system employs three LiDAR emitters and sensors strategically mounted on the front and back of a train to continuously scan railway corridors and railyards for anomalies. The system is designed to identify and geolocate holes, cuts, or breaches in perimeter and boundary fences, providing maintenance and security personnel for railways with precise Global Positioning System (GPS) coordinate data on compromised sections of their perimeter and rail corridor security.

The utilization of real-time LiDAR scanning and perception software automatically detects and identifies the exact GPS location of changes in fence integrity, differentiates between natural fencing gaps, and unlawful intrusions, and provides actionable insights to railway operators.

The LiDAR-based system continuously captures high-resolution point cloud data and analyzes the data through advanced machine learning algorithms which distinguish fence structures and fence integrity from a surrounding environment. Exact Global Positioning System (GPS) coordinates of a breach or an anomaly in or proximate to perimeter or corridor fencing are detected, logged and transmitted to railway monitoring centers for immediate response.

The precision and AI-driven anomaly detection capabilities of the LiDAR-based system enhance railway safety and mitigate liability risks associated with fence breaches significantly advancing railway security.

The present invention relates to a dynamic railway corridor and railyard zone creation and a perimeter and corridor fence tracking platform. This invention provides a method and system for real-time and retrospective monitoring of 3D LiDAR generated data within a digital representation of a physical environment.

The system allows users to interactively create zones of observation over a digital interface that reflects either a flat layout or a 3D LiDAR-driven model of a physical space. Upon identification of a desired observation zone, the system establishes a geographic representation corresponding to the selected physical location. All static and movement data—collected from LiDAR sensors—can be streamed or replayed in that observation zone, enabling both real-time detection and historical analytics.

### BRIEF DESCRIPTION OF DRAWINGS

FIG. 1 shows a block diagram of the LiDAR – Based Detection System for real-time recording and monitoring, and historical lidar data analysis and prediction system to improve the safety of railways;

FIG. 2 is a perspective view of a train using the LiDAR – Based Detection System;

FIG. 3 is a top view of the front of a train having LiDAR emitters and LiDAR sensors showing projection/detection fields; and

FIG. 4 is a detail top view of the front of a train having LiDAR emitters and LiDAR sensors showing projection/detection fields.

### DETAILED DESCRIPTION OF THE INVENTION

The LiDAR – Based Detection System 10 allows railway personnel to interactively establish geographically identified zones 30 of interest over a digital interface 22 that reflects either a flat layout or a 3D LiDAR-driven model of a physical space. Upon defining the desired observation zone 30, the LiDAR – Based Detection System 10 establishes an accurate digital representation corresponding to the selected physical location. All static and movement data—collected from LiDAR sensors 14 can be streamed or replayed for the desired observation zone 30, enabling both real-time detection and historical analytics.

The invention supports multiple applications, including:

A security module 18 providing security optimization, where observation zones 30 can be used to capture the presence of individuals within a railyard or railway corridor 32 to determine authorized access or unauthorized activity.

Safety enforcement, by identifying breaches 34 in perimeter and/or corridor fencing 36 and to issue warnings to locate and repair breaches 34 which may permit unauthorized egress to hazardous areas.

The LiDAR – Based Detection System 10 further enables breach identification, breach positioning, malicious destruction monitoring, the counting of fence breaches 34, the existence of debris on, or the disruption of a track 36, the existence and number of potential collisions with automobiles, the existence and number of potential collisions with individuals, the existence and number of potential collisions with animals or livestock, the existence and number of potential collisions with e-bikes and/or e-scooters, track monitoring, time of day trending, night compared to day analytics, as well as days of a week, week to week and month to month analytics, forming a foundational interface for infrastructure, maintenance, safety alerts, design modifications, and security applications.

The LiDAR – Based Detection System 10 creates dynamic geographically identified observation zones 30 over LiDAR telemetry data using a plurality of LiDAR emitters 12 and LiDAR sensors 14 positioned at the front and the back of a train 38, to cover a predetermined area, each lidar unit being wirelessly or wire connected to a LiDAR processor 16 running a program to monitor the travelled railway, the program providing a source of LiDAR observed and recorded data. The system also includes a digital interface 22 operable to display a 2D or 3D representation of a physical environment, based on observation of a travelled railway corridor or railyard 32.

The digital interface 22 also includes an interface module configured to allow a user to access, enhance, mark, move, or resize an observed zone 30 as depicted on a display. The LiDAR – Based Detection System 10 also includes a mapping engine 20 that translates the observed zone 30 into a physical geographically identified region or zone corresponding to the physical space captured by one or more of the LiDAR emitter-sensor units 12, 14. The LiDAR processor 16 aggregates and analyzes LiDAR point cloud data within the geographically identified region or zone 30. The digital Interface 22 also includes an output module configured to display real-time or historical observed breaches 34 or anomalies, safety considerations, or zone violations based on LiDAR data intersecting the defined observation zone 30. It should be noted that an anomaly may also include obstructions or other safety matters proximate to or upon a railroad crossing.

The LiDAR processor 16 within the comparison and detection module 24 detect and log any fence breaches 34, entry or exit events through fence breaches 34, the existence of debris on or disruption of a track, the existence and number of potential collisions with automobiles, the existence and number of potential collisions with individuals, the existence and number of potential collisions with animals or livestock, the existence and number of potential collisions with e-bikes and/or e-scooters, track monitoring, time of day trending, night compared to day analytics, as well as days of a week, week to week, and month to month analytics through or within a dynamic railway corridor 32 or dynamic railway yard. The dynamic railway corridor 32 or dynamic railway yard is associated with an identified geographic zone 30, and the telemetry processing engine determines the desired data from the scanned environment within any one or more of the identified geographic dynamic railway corridors 32 or dynamic railway yard zones 30, during a defined time window, such during daylight hours or during night hours.

The dynamic railway corridor 32 or dynamic railway yard geographic identified zones 30 are configured as safety exclusion zones, and the LiDAR – Based Detection System 10 replays LiDAR telemetry to detect any breach events that occurred within the exclusion zone during a user-defined time range. The digital interface 22 may also include a drag-and-drop features to enable real-time repositioning or resizing of the dynamic railway corridor 32 or dynamic railway yard geographically identified zones 30 with processed data automatically recalculated for the new position or dimensions of a train 38.

The digital interface 22 provides the ability to draw or drag a dynamic railway corridor 32 or dynamic railway yard zone 30 anywhere within a replay tool or real-time canvass and count the type, identify the location, and signal appropriate monitors as to the presence of an anomaly within a selected zone 30 in real time, as well as aggregate the identified anomalies over time, as well as to allow for replay of the observed anomaly in the identified zone 30 over any prior desired time period.

A method for zone-based processing and analysis is provided which includes providing a plurality of LiDAR emitters 12 and LiDAR sensors 14 positioned to cover a predetermined area, in front of and to the rear of a stationary or moving train 38, each LiDAR emitter 12 and LiDAR sensor 14 being wirelessly or hard wire connected to the LiDAR processor 16, running at least one software program to monitor the predetermined dynamic railway corridor 32 or dynamic railway yard zone 30.

The LiDAR processor 16 runs at least one software program that uses a recording module 26 to record and store the sensed LiDAR data in memory. The sensed LiDAR data is in communication with the mapping engine 20 to map the sensed LiDAR data onto a dynamic geographic display. The LiDAR – Based Detection System 10 in addition to the mapping engine 20 provides a digital interface 22 to assist an individual to review and to act upon information communicated by the communication module 28 as recorded within a geographic the monitored dynamic railway corridor 32 or dynamic railway yard area.

The LiDAR – Based Detection System 10 also enables a user to draw a zone 30 over a point of interest. The mapping engine 20 also provides for mapping the drawn zone to a physical location based on sensor-calibrated coordinates which may include GPS coordinate identifiers. The LiDAR – Based Detection System 10 further provides for the continuous collection or replay of sensed LiDAR data intersecting the selected dynamic railway corridor 32 or dynamic railway yard zone 30. The method also provides for generating reports, signals, warnings and other information concerning changes occurring within the physical environment within a selected dynamic railway corridor 32 or dynamic railway yard zone 30.

The dynamic railway corridor 32 or dynamic railway yard zone 30 activity data may be used to generate alerts generated by the security module 18 upon detection of unauthorized entries or openings 34 through a fence 40 providing egress into a railway corridor 32 or railway yard. Also, multiple zones 30 may be drawn and compared to measure variance across different time intervals or spatial configurations.

In a first embodiment a LiDAR – Based Detection System 10 is provided for detecting breaches 34 in railway perimeter fences 40, the system including at least three LiDAR sensors 14 mounted on a train 38, including one at the front of the train and two at the rear of the train, a LiDAR processor 16 configured to receive LiDAR data and to generate a point cloud representation of the railway perimeter or railway corridor 32, an anomaly detection module 24 utilizing perception algorithms to identify deviations in fence integrity and deviations in previously sensed and recorded LiDAR data within the railway perimeter or railway corridor 32; a mapping engine 20 to log the GPS coordinates of detected fence breaches 34 and identified anomalies occurring within the railway perimeter or railway corridor 32, and a communication module 28 to transmit alerts to a railway monitoring system.

In a second embodiment according to the first embodiment, the LiDAR sensors 14 continuously scan the front, the rear and both sides of the front and rear of a train 38, moving or stationary relative to railway tracks 36, to detect unauthorized gaps or cut sections in perimeter or corridor fences 40.

In a third embodiment according to the first embodiment, the detection module 24 utilizing perception algorithms differentiates between naturally occurring fence gaps and artificial breaches using machine learning-based anomaly detection.

In a fourth embodiment according to the first embodiment, GPS coordinates of a detected breach 34 are automatically overlaid onto the LiDAR data by the mapping engine 20 for precise breach location identification.

In a fifth embodiment according to the first embodiment, the detection module 24 utilizing perception algorithms provides real-time alerts, including timestamped images and 3D reconstructions of detected breaches 34 in perimeter or corridor fences 40.

In a sixth embodiment according to the first embodiment, the LiDAR sensors 14 are configured to operate under varying weather conditions and environmental obstructions to ensure accurate detection of breaches 34 in perimeter or corridor fences 40.

In a seventh embodiment according to the first embodiment, the detected fence breaches 34 in perimeter or corridor fences 40 are recorded by a recording module 26 in memory or in a database for historical analysis and predictive maintenance.

In an eighth embodiment according to the first embodiment, the LiDAR – Based Detection System 10 integrates with railway security networks to automate breach response protocols, including drone deployment or security dispatch.

In a ninth embodiment according to the first embodiment, sensed LiDAR data is processed on board the train 38 using edge computing to minimize latency in detecting fence breaches 34 in perimeter or corridor fences 40.

In a tenth embodiment according to the first embodiment, detection module 24 utilizing perception algorithms utilizes previously recorded LiDAR scans to compare and detect newly formed breaches 34 in perimeter or corridor fences 40 with a predefined threshold of anomaly detection.

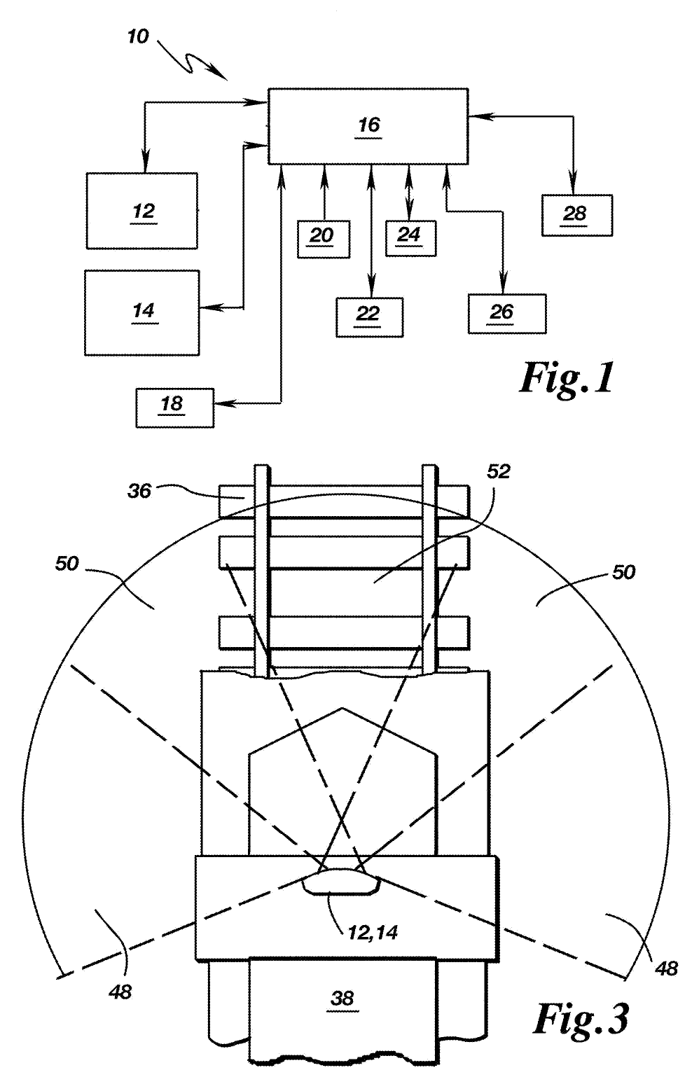

FIG. 1 shows a block diagram of LiDAR – Based Detection System 10 for recording and analysis of real-time and historical LiDAR data representative of geographic zones 30 proximate to a railroad track 36, to detect fence breaches 34 and other anomalies. The system operates on a LiDAR processor 16. The system 10 includes a plurality of LiDAR emitters 12 and LiDAR sensors 14 as secured to a train 38. The plurality of LiDAR emitters 12 and LiDAR sensors 14 are in communication with the LiDAR processor 16. The LiDAR processor 16 may be located inside or on the train 38. The LiDAR processor 16 includes machine learning algorithms and is in communication with the LiDAR emitters 12 and LiDAR sensors 14, the security module 18, the mapping engine 20, the digital interface 22, the detection module 24, the recording module 26, and the communication module 28.

In at least one embodiment, the LiDAR processor 16 will overwrite data onto the mapping engine 20 as data is received from the detection module 24 in order to increase the accuracy of the recording and analysis of real-time LiDAR data representative of geographic zones 30 proximate to a railroad track 36. In addition, the LiDAR processor 16 will compare and analyze the real-time LiDAR data using the machine learning algorithms with the previously recorded or historic LiDAR data as stored in memory to improve the accuracy of the real-time LiDAR data. The analyzed real-time LiDAR data will then be updated and recorded on the recording module 26 into memory for analysis by the detection module 24 and the security module 18.

A security module 18 is in communication with the LiDAR processor 16. The security module 18 includes security machine learning algorithms to determine the issuance of an alert warning or alert signal in real time, or on a selected delay, dependent upon the type and/or urgency of the LiDAR data detected by the detection module 24, as passed to the security module 18 through the LiDAR processor 16. Alternatively, the security module 18 may also be in direct communication with the detection module 24. The security module 18 optimizes the security machine learning algorithms to establish a plurality of thresholds to be assigned to the detected LiDAR data, where each threshold may be linked to a different magnitude of warning or alert signal. A security module 18 as in communication with the LiDAR processor 16 may issue any one or more warning or alert signals in real time to improve the safety and security of the train 28, railway corridor 32 and/or railway yard.

A digital interface 22 is operable to display a 2D or 3D LiDAR-driven model representation of a physical environment, based on sensed LiDAR data by the LiDAR sensors 14. The digital interface 22 is in communication with the LiDAR processor 16. The digital interface 22 may also be in communication with the mapping engine 20 and the detection module 24. The digital interface 22 also includes an interface module configured to allow a user to access, enhance, mark, move, or resize an observed zone 30 as depicted on a display. The digital interface 22 also includes an output module configured to display real-time or historical observed breaches 34 or anomalies, safety considerations, or zone violations based on detected or sensed LiDAR data intersecting the defined observation zone 30. The digital interface 22 may also include drag-and-drop features to enable real-time repositioning or resizing of the dynamic railway corridor 32 or dynamic railway yard geographically identified zones 30 with processed data automatically recalculated for the new position or dimensions of a train 38. The digital interface 22 provides the ability to draw or drag a dynamic railway corridor 32 or dynamic railway yard zone 30 anywhere within a replay tool or real-time canvass, and count the type, identify the location, and signal appropriate personnel as to the presence of an anomaly within a selected zone 30 in real time, as well as aggregate the identified anomalies over time, as well as to allow for replay of the observed anomaly in the identified zone 30 over any prior desired time period.

A mapping engine 20 is in communication with the LiDAR processor 16. The mapping engine 20 in conjunction with the digital interface 22 provides the drawing module which is configured to allow a user to draw, move, or resize a zone 30 on the displayed environment. The mapping engine 20 may also translate the drawn zone 30 into a displayed physical geofenced region corresponding to the physical space captured by one or more LiDAR sensors 14. The mapping engine 20 translates the observed zone 30 into a physical geographically identified region or zone 30 corresponding to the physical space captured by one or more of the LiDAR emitter-sensor units 12, 14. The mapping engine 20 also provides for mapping the drawn zone to a physical location based on sensor-calibrated coordinates which may include GPS coordinate identifiers assigned to individual anomalies or fence breaches 34 as detected within all zones proximate to a railway corridor 32 or railway yard.

The mapping engine 20 creates a dynamic railway corridor 32 or railway yard as the train 28 moves along the railroad tracks 36. The mapping engine 20 also includes machine learning algorithms to facilitate the assignment of GPS coordinates to identified anomalies or fence breaches 34. The mapping engine 20 also provides dynamic perimeter or railway corridor fencing images in 2D or 3D to facilitate security proximate to a railway, to improve maintenance to railroad track 36 and fencing 40, and to reduce accidents as well as railroad liability.

The mapping engine 20 additionally creates Geospace or interactive zones of interest 30 which in some embodiments may be established through the use of the machine learning algorithms. The mapping engine 20 in conjunction with the LiDAR processor 16 may receive LiDAR data and generate high-resolution point cloud images of zones 30 to distinguish fence structures and fence integrity from a surrounding environment.

A recording module 26 is in communication with the LiDAR processor 16. The recording module 26 continuously captures and records the high-resolution point cloud images of zones 30 as detected from the LiDAR sensors 14 into memory. The recording module 26, as in communication with the mapping engine 20, will log the date, time, GPS location of sensed LiDAR data in real time to establish a historic record of the environment adjacent to a moving train 28. The recorded LiDAR data will be available for access by the machine learning functions of the LiDAR processor 16, security module 18, mapping engine 20 and detection module 24 to provide predictive information to improve the accuracy of the high-resolution point cloud images of zones 30, and the security and safety for a railway.

The system 10 also includes a detection module 24 in communication with the LiDAR processor 16. The detection module 24 includes advanced machine learning algorithms. The advanced machine learning algorithms may include machine learning perception software to enhance anomaly and breach 34 detection over time. The detection module 24 may aggregate and analyze LiDAR point cloud data within one or more geofenced regions simultaneously or consecutively. The machine learning algorithms or artificial intelligence AI establish and refine anomaly threshold detection levels as well as fence breach 34 recognition. The detection module 24, from analysis of the historic LiDAR data, distinguishes between naturally occurring environmental features which may include gaps or other structure, from unnatural or unlawful anomalies including but not necessarily limited to cuts, holes, obstructions, wear, vandalism, openings, or other types of objects or fence breaches 34 proximate to a railway corridor 32 or railway yard.

The LiDAR – Based Detection System 10 also includes a communication module 28 in communication with the LiDAR processor 16. The communication module 28 may include one or more LiDAR data transmitters 42 and one or more data LiDAR data receivers 44. The LiDAR data transmitters 42 and the LiDAR data receivers 44 send and receive data signals 46 as sensed by the LiDAR sensors 14, and as refined by the security module 18, the mapping engine 20, the detection module 24, the recording module 26, communication module 28 and the LiDAR processor 16. In at least one embodiment, the LiDAR data transmitters 42 are preferably mounted on a train 28 and are constructed and arranged to generate the data signals 46 as directed from the LiDAR processor 16 through the communication module 28.

In some embodiments, a plurality of LiDAR data receivers 44 are disposed along a railway corridor 32 for receipt of the data signals 46 as emitted by the LiDAR data transmitters 42. It should also be noted that the LiDAR data receivers 44 may include a signal transmitter and the LiDAR data transmitters 42 may include a signal receiver to send or to receive communication signals from a remote base station and as passed through the communication module 28 to the LiDAR processor 16. The data signals 46 as received by the LiDAR data receivers 44 from the communication module 28, and as transmitted by the LiDAR data transmitters 42 are in turn communicated to a remote railway base station for monitoring. The remote railway base station upon receipt of any signal warnings from the communication module 28 and the security module 18 may then command the deployment of a drone for additional observation, a security response, or a maintenance team to address any detected anomaly or fence breach 34 in real time.

In at least one embodiment, the communication module 28 is configured to display real-time or historical movement patterns, people count, or zone violations based on LiDAR data intersecting the defined zone 30.

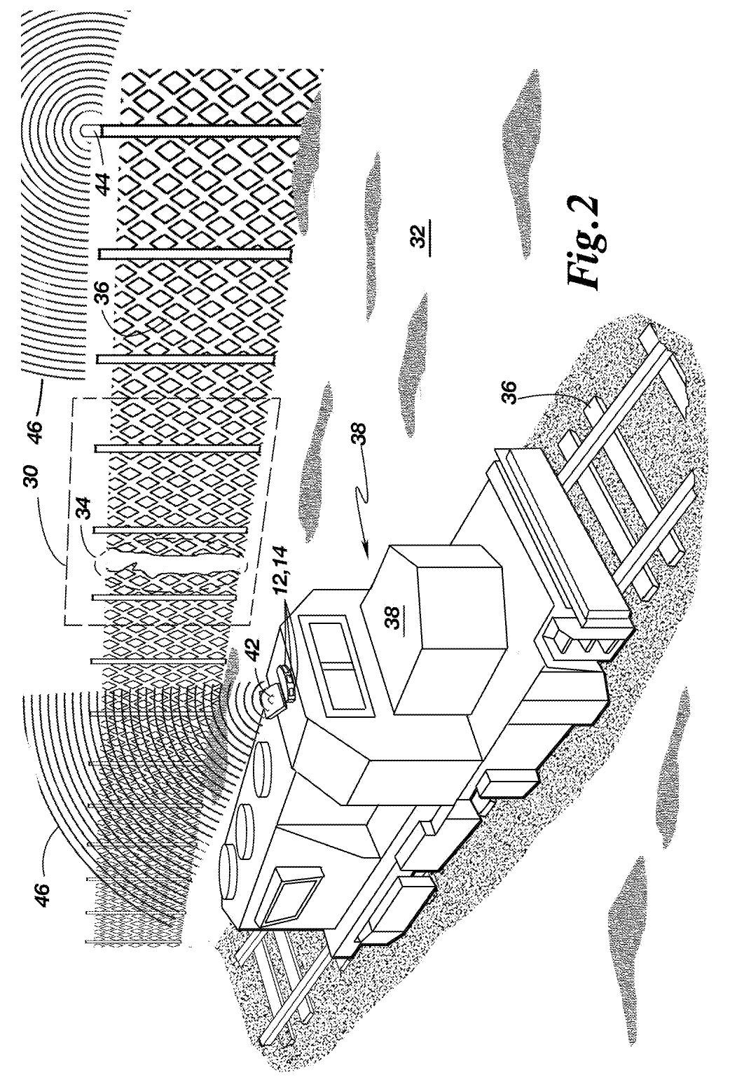

FIG. 2 shows an environmental view of a train 28 equipped with the LiDAR – Based Detection System 10 moving along railroad tracks 36.

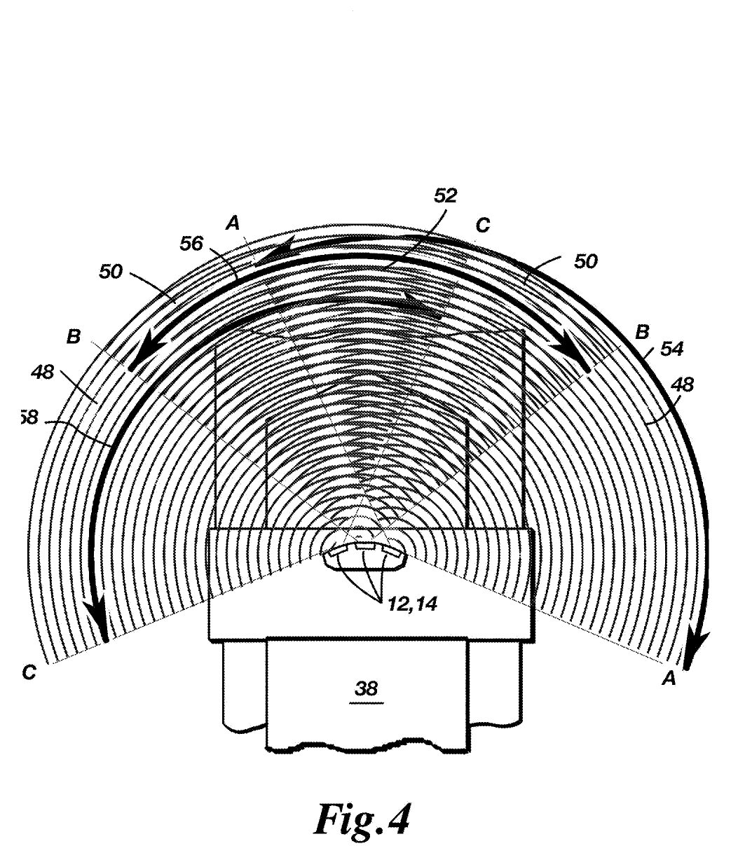

FIG. 3 and FIG. 4 show the front of a train 38 including LiDAR emitters 12 and LiDAR sensors 14. As may be seen in FIG. 3 and FIG. 4 at least one, two, three or more LiDAR emitters 12 and LiDAR sensors 14 may be mounted proximate to the top and front of a train 28. The LiDAR emitters 12 and LiDAR sensors 14 may be mounted to the front of a train at other locations in order to optimize performance of the LiDAR – Based Detection System 10.

In addition, at least one, two, three or more LiDAR emitters 12 and LiDAR sensors 14 may be mounted proximate to the top and rear or back of a train 28. The LiDAR emitters 12 and LiDAR sensors 14 may be mounted to the rear or back of a train at other locations in order to optimize performance of the LiDAR – Based Detection System 10.

Also, it is not required that an equal number of LiDAR emitters 12 and LiDAR sensors 14 be mounted to the front and rear or back of the train 28. Either the front or the rear or back of the train 28 hay have a higher or lower number of LiDAR emitters 12 and LiDAR sensors 14 as required for a particular application, a desired level of performance or a weather condition to name a few of the variables which may be considered in the decision as to the number of LiDAR emitters 12 and LiDAR sensors 14 to be used proximate to the front or rear or back of a train 28.

It should be noted that the features, functions and descriptions provided concerning the inclusion of the LiDAR emitters 12 and LiDAR sensors 14 proximate to the front of a train 28 are equally applicable for the LiDAR emitters 12 and LiDAR sensors 14 disposed proximate to the rear or back of the train and do not require repetition herein.

The LiDAR emitters 12 and LiDAR sensors 14 each have a projection/detection field 48 which may be at an acute, obtuse or right angle relative to the LiDAR emitters 12 and LiDAR sensors 14 to define a field of observance for accumulation of LiDAR data. In at least one embodiment when two or more LiDAR emitters 12 and LiDAR sensors 14 are utilized, each of the projection/detection fields 48 may include a first overlap area 50. In embodiments where three or more LiDAR emitters 12 and LiDAR sensors 14 are utilized, the projection/detection field 48 may include the first overlap area 50 and a second or subsequent overlap area 52. Any number of overlap areas 52 may be provided dependent upon the number of LiDAR emitters 12 and LiDAR sensors 14 utilized. It should be noted that any number of LiDAR emitters 12 and LiDAR sensors 14 may be utilized at the discretion of an operator and that the number of LiDAR emitters 12 and LiDAR sensors 14 disposed proximate to the front of a train 28 may be more or less than three and that the number of LiDAR emitters 12 and LiDAR sensors 14 disposed proximate to the rear or back of a train 28 may be more or less than three.

In at least one embodiment the projection/detection field 48 is sensed by a single unit of a LiDAR emitter 12 and a LiDAR sensor 14. In an alternative embodiment, a first overlap area 50 is sensed by the use of two independent LiDAR emitters 12 and LiDAR sensors 14. In a further embodiment, the second or subsequent overlap area 52 may be sensed through the use of three or more independent LiDAR emitters 12 and LiDAR sensors 14.

Overlapping sensed LiDAR data from overlapping projection/detection fields 48 may be used by the advance machine learning capabilities of the system 10 to improve recognition and prediction of anomalies and fence breaches 34. The angular area of sensed data for each projection/detection field 48 may vary between 20 degrees and up to 160 degrees. The utilization of overlapping projection/detection fields 48 is desirable to improve the collection of LiDAR data proximate to the edges of a particular angular field of observance.

Each of the LiDAR emitters 12 and LiDAR sensors 14 may have a reach that is dependent on the environment to be sensed or observed. In some embodiments the reach of the LiDAR emitters 12 and LiDAR sensors 14 may be measured in meters or yards and may exceed 50 meters or yards. In other embodiments, the reach of the LiDAR emitters 12 and LiDAR sensors 14 may be measured in miles or kilometers and may exceed 1 mile or 1.6 kilometers. In other embodiments the reach of the LiDAR emitters 12 and LiDAR sensors 14 may be less than 50 meters or greater than 1.6 kilometers.

As depicted in FIG. 4 one set of LiDAR emitters 12 and LiDAR sensors 14 may generate and receive signals between lines A – A, at an established defined angle represented by line 54. Another set of LiDAR emitters 12 and LiDAR sensors 14 may generate and receive signals between lines B – B, at an established defined angle represented by line 56. Further, another set of LiDAR emitters 12 and LiDAR sensors 14 may generate and receive signals between lines C – C, at an established defined angle represented by line 56.

In some embodiments, the projection/detection field 48 defined by angle A – A is equal to the projection/detection field 48 defined by angle B – B and defined by angle C – C. In other embodiments, two of the projection/detection fields 48 defined by angles A – A, B – B and C – C may be equal to each other in any combination. In another alternative embodiment, the projection/detection fields 48 defined by angles A – A, B – B and C – C are each different form each other.

In the embodiment depicted in FIG. 4 the projection/detection field 48 defined by angle A – A is directed towards the center and right relative to the front of the train 28. The projection/detection field 48 defined by angle B – B is directed towards the center relative to the front of the train 28 and the projection/detection field 48 defined by angle C – C is directed towards the center and left relative to the front of a train 28.

It should be noted that the rear of the train 38 may also have the projection/detection fields 48 and defined angle characteristics as identified above relative to the front of the train 38.

It should also be noted that the configuration for the projection/detection fields 48 from the front of a train 38 are not required to be identical to the projection/detection fields 48 from the rear of the train 38. In at least one embodiment, the configuration for the projection/detection fields 48 for the front of the train 38 are equal to the projection/detection fields 48 on the rear of the train 38.

This completes the description of the preferred and alternate embodiments of the invention. Those skilled in the art may recognize other equivalents to the specific embodiment described herein which equivalents are intended to be encompassed by the claims attached hereto.

The above disclosure is intended to be illustrative and not exhaustive. This description will suggest many variations and alternatives to one of ordinary skill in this art. The various elements shown in the individual figures and described above may be combined or modified for combination as desired. All these alternatives and variations are intended to be included within the scope of the claims where the term “comprising” means “including, but not limited to”.

These and other embodiments which characterize the invention are pointed out with particularity in the claims annexed hereto and forming a part hereof. However, for further understanding of the invention, its advantages and objectives obtained by its use, reference should be made to the drawings which form a further part hereof and the accompanying descriptive matter, in which there is illustrated and described embodiments of the invention.

1. A system for detecting anomalies proximate to a railway, the system comprising:
at least one LiDAR emitter and LiDAR sensor engaged to a front of a train, said at least one LiDAR emitter and LiDAR sensor generating and receiving LiDAR signals representative of an environment proximate to said train;
a LiDAR processor engaged to said train, said LiDAR processor being in communication with said at least one LiDAR emitter and LiDAR sensor, said LiDAR processor receiving said LiDAR signals, said LiDAR processor comparing and transforming said LiDAR signals into a composite LiDAR data signal;
a detection module in communication with said LiDAR processor, said detection module reviewing said LiDAR data signal and identifying at least one of said anomalies proximate to said railway;
a mapping engine in communication with said LiDAR processor, said mapping engine assigning coordinates for said at least one of said anomalies; and
a communication module in communication with said LiDAR processor, said communication module having at least one LiDAR data transmitter, said communication module communicating said coordinates for said at least one of said anomalies to a LiDAR data receiver separated from said train.

2. The system of claim 1, further comprising a security module in communication with said LiDAR processor, said security module assigning at least one level of security warning for said at least one of said anomalies.

3. The system of claim 1, further comprising a digital interface, said digital interface being in communication with said LiDAR processor, said digital interface having an interface module, said digital interface enabling identification of at least one zone, said interface module being constructed and arranged to permit at least one of access, enhancement, marking, movement, and resizing of said at least one zone as depicted on a display.

4. The system of claim 1, further comprising a recording module, said recording module being in communication with said LiDAR processor, said recording module recording and storing said LiDAR data signal.

5. The system of claim 1, wherein said at least one of said anomalies is a breach through a fence.

6. The system of claim 1, said system having at least two LiDAR emitters and LiDAR sensors said at least two LiDAR emitters and LiDAR sensors being constructed and arranged to generate a projection/detection field, said projection/detection field having at least one overlap area.

7. The system of claim 1, said system having at least three LiDAR emitters and LiDAR sensors said at least three LiDAR emitters and LiDAR sensors being constructed and arranged to generate a projection/detection field, said projection/detection field having at least one overlap area and at least one second overlap area.

8. The system of claim 1, wherein at least one of said LiDAR processor, said detection module, and said mapping engine comprises machine learning algorithms.

9. The system of claim 1, wherein said LiDAR emitters and LiDAR sensors are engaged to said front and a rear of said train.

10. The system of claim 2, wherein said security module comprises machine learning algorithms.

11. The system of claim 3, wherein said digital interface comprises machine learning algorithms.
